(19) United States
(12) Patent Application Publication
(10) Pub. No.: US 2020/0235950 A1
(43) Pub. Date: Jul. 23, 2020

(54) COMMUNICATION DEVICE, VEHICLE HAVING THE SAME AND METHOD FOR CONTROLLING THE SAME

(71) Applicants: Hyundai Motor Company, Seoul (KR); Kia Motors Corporation, Seoul (KR)

(72) Inventor: Taehwan Park, Seoul (KR)

(21) Appl. No.: 16/597,557

(22) Filed: Oct. 9, 2019

(30) Foreign Application Priority Data
Jan. 22, 2019 (KR) 10-2019-0008023

(51) Int. Cl. H04L 12/12; H04W 52/02; H04W 4/48

(52) U.S. Cl. CPC H04L 12/12; H04W 4/48; H04W 52/0229; H04W 52/0216

(57) ABSTRACT

A vehicle includes controllers and a communication device that, when receiving a wake-up packet to be transmitted from a first to a second controller, stores the wake-up packet, transmits a wake-up signal to the second controller, and when a ready signal is received by the second controller, transmits the wake-up packet to the second controller. The communication device includes ports connected to the controllers. When a wake-up packet is received by a first controller connected to one of the ports, a switch unit identifies a second controller to transmit the wake-up packet, and performs switching with the port to which the identified second controller is connected. A queue stores the wake-up packet and a first microcomputer transmits a wake-up signal to the second controller. When a ready signal is received by the second controller, the first microcomputer transmits the wake-up packet stored in the queue to the second controller.

### CROSS-REFERENCE TO RELATED APPLICATION(S)

This application claims priority to and the benefit of Korean Patent Application No. 10-2019-0008023, filed on Jan. 22, 2019, the disclosure of which is incorporated by reference in its entirety.

### BACKGROUND

### 1. Technical Field

The present disclosure relates to a communication device for transmitting a wake-up packet to a controller that performs a sleep mode, a vehicle having the communication device, and a method of controlling the communication device.

### 2. Description of the Related Art

In addition to basic driving functions, vehicles perform additional functions for user convenience such as an audio function, a video function, a navigation function, an air conditioning function, a seat heating function and communication with an external terminal. To perform the various functions, the vehicle shares various data by communicating with an electronic control unit (ECU) or a controller configured to execute the various functions, a power plant (or a power system), a brake system, a steering system, a camera, various sensors, an input device, and a display device by utilizing various communication devices such as controller area network (CAN), FlexRay, media oriented systems transport (MOST), and Ethernet.

Various devices provided in the vehicle may be switched to a sleep mode or may be woken up by the communication device. In other words, the various devices provided in the vehicle may be switched to the sleep mode by the communication device when not in operation, and may be woken up by the communication device when data provision is requested in another device or when a function is to be performed. The various devices receive a wake-up signal transmitted from another device, and then receive a packet that includes a message transmitted from another device.

In particular, the various devices require a certain period of time from when the wake-up signal is received until when booting is completed. If the packet is transmitted from another device between a point in time after the wake-up signal is received and a point in time before the booting is completed, the packet transmitted from other devices is unable to be received causing data not to be able to be shared among the devices.

### SUMMARY

Therefore, the present disclosure provides a communication device which stores a packet when transmitting a wake-up signal from a first controller to a second controller and transmits the stored packet to the second controller upon receiving a ready signal by the second controller, a vehicle having the communication device, and a method of controlling the communication device.

It is another aspect of the present disclosure to provide a communication device that may include a first microcomputer configured to execute wake-up of at least one controller and a second microcomputer configured to convert the at least one controller to a sleep mode, a vehicle having the communication device, and a method of controlling the communication device.

In accordance with one aspect of the present disclosure, a communication device may include a plurality of ports respectively connected to a plurality of controllers; a switch unit configured to, when a wake-up packet is received by a first controller connected to one of the plurality of ports, identify a second controller to transmit the received wake-up packet, and perform switching with the port to which the identified second controller is connected; a queue configured to store the received wake-up packet; and a first microcomputer configured to transmit a wake-up signal to the second controller, and when a ready signal is received by the second controller, transmit the wake-up packet stored in the queue to the second controller.

The switch unit may be configured to store identification information of the plurality of controllers. The communication device may further include a second microcomputer configured to identify an operation state of the plurality of controllers. When at least one controller among the plurality of controllers is not operated for a predetermined time or longer, the second microcomputer may be configured to convert the at least one controller from an operating mode to a sleep mode. When the at least one controller is in the operating mode, the second microcomputer may be configured to execute operations for transmitting and receiving data with another controller.

When the ready signal is received by the second controller, the first microcomputer may be configured to transmit a message in the wake-up packet stored in the queue. When a packet transmitted by the first controller connected to one of the plurality of ports is the wake-up packet, the switch unit may be configured to generate the wake-up signal. The switch unit may be configured to store identification information that corresponds to each of the plurality of controllers in a table. When transmission of the wake-up packet stored in the queue is completed, the first microcomputer may be configured to delete the wake-up packet stored in the queue.

In accordance with another aspect of the disclosure, a vehicle may include a plurality of controllers; and a communication device configured to, when receiving a wake-up packet to be transmitted from a first controller to a second controller among the plurality of controllers, store the received wake-up packet, transmit a wake-up signal to the second controller, and when a ready signal is received by the second controller, transmit the stored wake-up packet to the second controller.

The communication device may include: a plurality of ports respectively connected to the plurality of controllers; a plurality of first microcomputers respectively connected to the plurality of ports, and configured to execute storage and transmission of the wake-up packet; a plurality of queues respectively connected to the plurality of first microcomputers, and configured to store the wake-up packets; a switch unit configured to identify the second controller to transmit the wake-up packet, and perform switching with the port to which the identified second controller is connected; and a second microcomputer connected to the plurality of ports, and configured to execute a sleep mode of the plurality of controllers, and execute operations for transmitting and receiving data between the controllers performing an operating mode of the plurality of controllers.

The switch unit of the communication device may be configured to store identification information that corresponds to each of the plurality of controllers in a table. The second microcomputer of the communication device may be configured to identify an operation state of the plurality of controllers, and when at least one controller among the plurality of controllers is not operated for a predetermined time or longer, convert the at least one controller from the operating mode to the sleep mode. When a packet transmitted by the first controller connected to one of the plurality of ports is the wake-up packet, the switch unit of the communication device may be configured to generate the wake-up signal.

The communication device may be configured to store the received wake-up packet in a queue, when the ready signal is received by the second controller, transmit the wake-up packet stored in the queue, and when transmission of the wake-up packet stored in the queue is completed, delete the wake-up packet stored in the queue. The communication device may include an Ethernet switch hub. When the wake-up signal is received, the second microcomputer may be configured to perform a boot, and when booting is complete, transmit the ready signal to the communication device.

In accordance with another aspect of the disclosure, a method for controlling a communication device may include: when receiving a wake-up packet by a first controller connected to one of a plurality of ports, identifying a second controller to transmit the received wake-up packet; performing switching with the port to which the identified second controller is connected; storing the received wake-up packet in a queue; transmitting a wake-up signal to the identified second controller; and when a ready signal is received by the second controller, transmitting the wake-up packet stored in the queue to the second controller.

The transmitting of the wake-up packet stored in the queue to the second controller may include: transmitting a message in the wake-up packet stored in the queue. The method for controlling the communication device may further include: when a packet transmitted by the first controller is the wake-up packet, generating the wake-up signal; and when transmission of the wake-up packet stored in the queue is completed, deleting the wake-up packet stored in the queue.

### BRIEF DESCRIPTION OF THE DRAWINGS

These and/or other aspects of the disclosure will become apparent and more readily appreciated from the following description of the exemplary embodiments, taken in conjunction with the accompanying drawings of which:

FIG. 1 is an exemplary view illustrating a communication device and a plurality of devices provided with a vehicle according to an exemplary embodiment;

FIG. 2 is a block diagram illustrating the communication device and the plurality of devices provided in the vehicle of FIG. 1 according to an exemplary embodiment;

FIGS. 3A and 3B are exemplary views illustrating network architecture of the communication device and the plurality of devices provided with the vehicle according to an exemplary embodiment;

FIG. 4 is a block diagram illustrating the communication device provided with the vehicle according to an exemplary embodiment;

FIGS. 5A, 5B and 5C are exemplary views illustrating a wake-up packet transmitted and received between the communication device and the plurality of devices provided with the vehicle according to an exemplary embodiment; and

FIG. 6 is a flowchart illustrating an example of a control method of the communication device for communication between the plurality of devices provided in the vehicle according to an exemplary embodiment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the following description, like reference numerals refer to like elements throughout the specification. Well-known functions or constructions are not described in detail since they would obscure the one or more exemplar embodiments with unnecessary detail. Terms such as “unit,” “device” and “apparatus” may be embodied as hardware or software. According to embodiments, a plurality of “units,” “devices” and “apparatuses” may be implemented as a single component or a single “unit,” “device” and “apparatus” may include a plurality of components.

It will be understood that when an element is referred to as being “connected” to another element, it can be directly or indirectly connected to the other element, wherein the indirect connection includes connection via a wireless communication network. Throughout the description, when a member is “on” another member, this includes not only when the member is in contact with the other member, but also when there is another member between the two members. It will be understood that, although the terms first, second, third, fourth, fifth, etc., may be used herein to describe various elements, it is should not be limited by these terms. These terms are only used to distinguish one element from another element. An identification code is used for the convenience of the description but is not intended to illustrate the order of each step. Each of the steps may be implemented in an order different from the illustrated order unless the context clearly indicates otherwise.

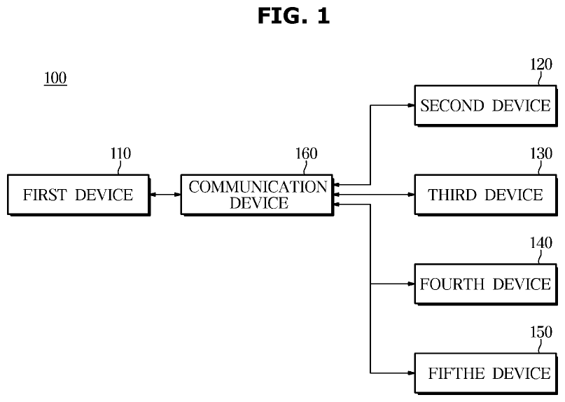

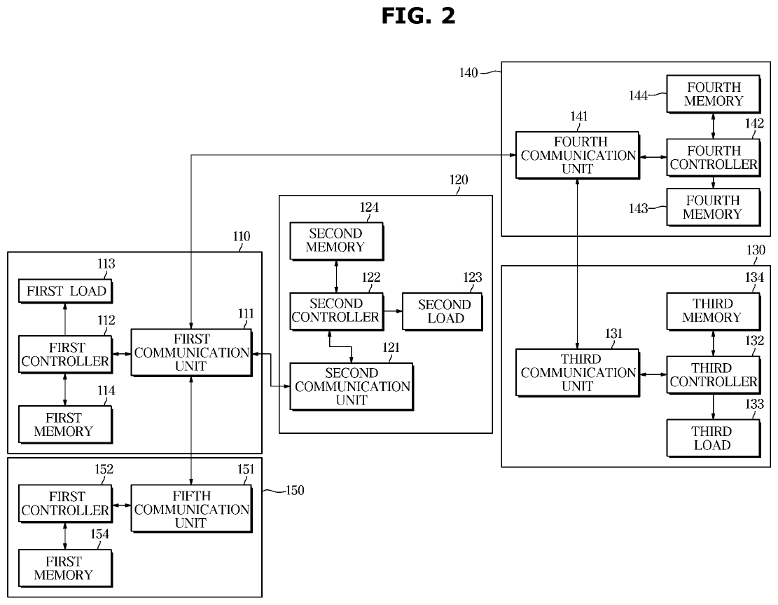

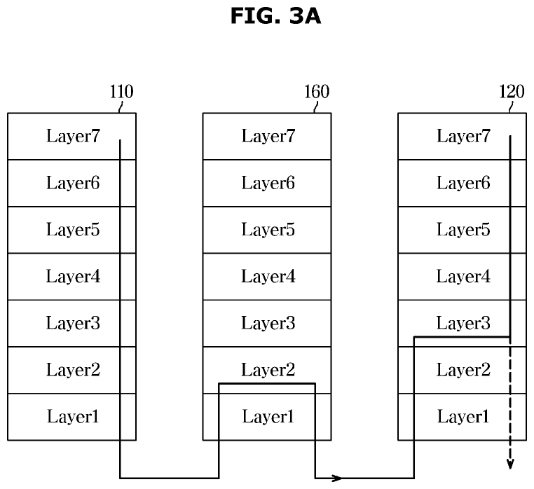

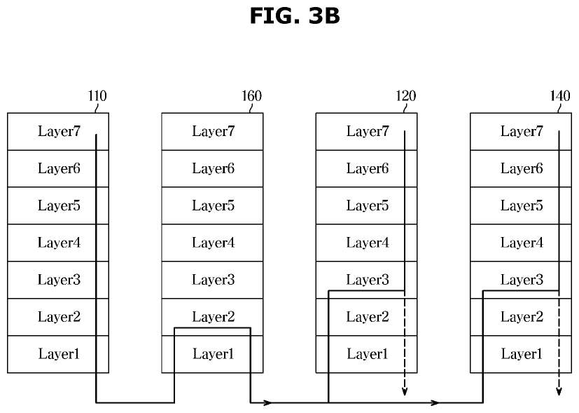

Reference will now be made in detail to exemplary embodiments of the present disclosure, examples of which are illustrated in the accompanying drawings. FIG. 1 is an exemplary view illustrating a communication device and a plurality of devices provided with a vehicle according to an exemplary embodiment. FIG. 2 is a block diagram illustrating the communication device and the plurality of devices provided in the vehicle of FIG. 1. FIGS. 3A and 3B are exemplary views illustrating network architecture of the communication device and the plurality of devices provided with the vehicle according to an exemplary embodiment.

As illustrated in FIG. 1, a vehicle 100 may include at least one device for performing at least one function. The number of devices may be one or more. By using a communication device 160 that is provided inside each of the devices, a plurality of devices 110, 120, 130, 140, and 150 may be configured to perform communication with each other, and transmit and receive various messages for performing at least one function during the communication.

The vehicle may include the communication device 160 configured to, when transmitting a message from one of the plurality of devices 110, 120, 130, 140, and 150 to at least one other device, set a message transmission path to the at least one other device, and control the message transmission. The communication device 160 may be configured to communicate using at least one of wired communication and wireless communication, and relay communication between at least two devices. The communication device 160 may be an Ethernet switching hub for transmitting a packet received from one port to another device through another port. The communication device 160 may include one of an access point (AP), a router, and a point-to-point. The communication device 160 may be implemented as a single device.

A plurality of devices (or apparatuses) provided in the vehicle will be described as an example. The plurality of devices provided in the vehicle 100 may include at least two of a lamp, an antenna, a cluster, a head unit, an audio/video/navigation (AVN) terminal, at least one camera, a head-up display (HUD), and an advanced driver assistance system (ADAS).

The lamp may be disposed in an exterior of a vehicle body and configured to allow a user to identify information regarding the surroundings while observing the forward view, and configured to perform signal and communication functions with other vehicles and pedestrians. The antenna may be configured to receive signals from global positioning system (GPS) satellites and a broadcasting station, and enable a wireless vehicle network (Vehicle to everything (V2X) communication) such as vehicle to vehicle (V2V) communication, and vehicle to infrastructure (V2I) communication, with another vehicle. The cluster may be disposed in an interior of the vehicle body and the head unit may be configured to receive an operation command of an audio device and an air conditioner. The at least one camera may be configured to collect an image of the surroundings of the vehicle for safety and convenience of the user. The head-up display (HUD) may then be configured to project navigation information to a front window glass so that the front window glass displays the navigation information that corresponds to a navigation function.

The plurality of devices may further include an input device, a display device, a gear control lever, a parking button for inputting an operation command of an electronic parking brake system (EPB button) (not shown), a power system, a steering system, a brake system configured to apply a braking force to vehicle wheels, and a suspension device configured to regulate a suspension of the vehicle. The plurality of devices may further include a detector such as a wheel speed sensor, an acceleration sensor, a steering angle sensor, a rain sensor, a yaw sensor, a pressure sensor, and an obstacle sensor.

The plurality of devices may further include a warning system configured to output alarm information in a dangerous situation to provide a notification to a driver regarding a dangerous situation of an accident, an automatic emergency braking system (AEBS) for emergency braking by operating the brake system and reducing an output of an engine when another vehicle is positioned within a predetermined distance in front of the vehicle, an airbag control system, an Electronic Stability Control (ESC) for maintaining the stability of the vehicle when accelerating or cornering, a tire pressure monitoring system (TPMS), and an Anti-lock Brake System (ABS) for preventing the wheels from being locked during sudden braking.

The warning system may include a Lane Departure Warning System (LDWS) that indicates a departure from a lane, a drowsiness warning system that indicates that the driver is in a drowsy state, a blind spot warning system (BSW, BSA or BSD) that indicates the risk of collision with other vehicles located on the left and the right sides of the lane of the vehicle, and a Forward Collision Warning System (FCWS) and Back Warning System (BWS) that indicates the risk of collision with other vehicles located in the front side and the rear side on the same lane of the vehicle.

However, an exemplary embodiment is not limited thereto, and thus the plurality of devices may further include various electronic devices disposed within the vehicle. For example, the first device 110 may be the audio-video navigation (AVN) terminal, the second device 120 may be the HUD, the third device 130 may be the cluster, the fourth device 140 may be the head unit, and the fifth device 150 may be the advanced driver assistance system (ADAS).

As illustrated in FIG. 2, the plurality of devices 110, 120, 130, 140, and 150 may be electrically connected to each other by the communication device 160 and may be configured to transmit and receive data to/from each other by the communication device 160. Each of the devices 110, 120, 130, 140, and 150 may include communication units 111, 121, 131, 141, and 151 configured to perform communication with other devices via the communication device 160, controllers 112, 122, 132, 142, and 152 configured to generate a control signal based on a message received via the communication units 111, 121, 131, 141, and 151, and an internal program, loads 113, 123, 133, and 143 configured to be operated in response to the generated control signal, and memories 114, 124, 134, 144, and 154 configured to store identification information of another device to which the message is to be transmitted based on the identification information of the message and store a destination IP address.

Some of the plurality of devices 110, 120, 130, and 140 may include the loads 113, 123, 133, and 143 that operate in response to a control signal of the controller. The remaining device 150 of the plurality of devices may be configured to transmit a control signal of the controller 152 to another device so that the load of the other device is operated. In other words, the controller of each of the devices may be a load controller that controls the operation of the load.

In addition, the controller of each of the devices may be a function execution controller configured to execute some of the functions that may be performed in the load of another device. For example, when the first device is a device performing a navigation function, a first load of the first device may be a display, a first controller of the first device may be a controller configured to generate route information, controlling the generated route information matched with map information to be displayed, and controlling the output of route guidance information.

When the fifth device performs the driving assist function, a fifth controller of the fifth device may be configured to obtain a distance from an obstacle located in a blind spot while the vehicle is being driven, and calculate the distance to the obstacle of the blind spot in response to determining that there is a risk of collision with the obstacle, determine whether there is the risk of collision with the obstacle in the blind spot based on the distance to the obstacle of the blind spot, and transmit blind spot alarm information to the first device to trigger the blind spot alarm information to be displayed on the display, which is the first load of the first device, in response to determining that there is the risk of collision with the obstacle.

The communication units 111, 121, 131, 141, and 151 of each of the devices may be configured to perform data transmission/reception operations based on control commands of the controllers 112, 122, 132, 142, and 152, and transmit a wake-up signal to the controller when the wake-up signal is received during a sleep mode.

The controllers 112, 122, 132, 142 and 152 of each device may be configured to operate each of the communication units 111, 121, 131, 141, and 151 to transmit a message that corresponds to a control signal, to another device. The controllers 112, 122, 132, 142, and 152 of each of the devices may include a communication function. Each of the devices may include a communication terminal electrically and mechanically connected to a port of the communication device 160.

The controller of each of the devices may be configured to assign an IP address upon transmitting and receiving a message to and from another device connected via the communication terminal. The controllers 112, 122, 132, 142, and 152 of each of the devices may be configured to perform an operating mode for performing at least one function when a power button is turned on in a state in which commercial power is supplied, and perform a sleep mode when the button is turned off in a state in which the commercial power is supplied. The commercial power may be external power.

The controllers 112, 122, 132, 142, and 152 of each of the devices may be configured to convert a current mode to the operating mode when the wake-up signal is received in the sleep mode, and convert the current mode to the sleep mode when a signal instructing to perform the sleep mode is received in the operating mode. The controllers 112, 122, 132, 142, and 152 of each of the devices may be configured to convert the sleep mode when a signal instructing to perform the sleep mode is received in the operating mode, and convert to the operating mode that performs at least one function selected by the user when the wake-up signal is received in the sleep mode.

Additionally, the controllers 112, 122, 132, 142, and 152 of each of the devices allow power to be supplied only to the communication units 111, 121, 131, 141, and 151 to use minimum power in the sleep mode, and allow power for driving to be supplied to all elements in the operating mode. The controllers 112, 122, 132, 142, and 152 of each of the devices may be respectively provided inside of the memories 114, 124, 134, and 144, or alternatively, the controllers 112, 122, 132, 142, and 152 may be separately provided from the memories 114, 124, 134, and 144.

The memories 114, 124, 134, and 144 of each of the devices may be configured to store an IP address, in the form of a table. In particular, the memories 114, 124, 134, and 144 of each of the devices may be a memory in which a program for executing an operation of the load is stored, and may be a memory in which a program for performing at least one function is stored. The controller of each of the devices may be implemented using a memory (not shown) configured to store an algorithm for executing an operation of components in the device and data related to programs implementing the algorithm, and a processor (not shown) performing the above mentioned operation using the data stored in the memory. The memory and the processor may be implemented in separate chips or a single chip.

The memory of each of the devices may be implemented using at least one of a non-volatile memory element, e.g., a cache, Read Only Memory (ROM), Programmable ROM (PROM), Erasable Programmable ROM (EPROM), Electrically Erasable Programmable ROM (EEPROM) and flash memory, a volatile memory element, e.g., Random Access Memory (RAM), or a storage medium, e.g., Hard Disk Drive (HDD) and CD-ROM. The implementation of the memory is not limited thereto.

Each memory may be a memory that is implemented by a chip separate from the above mentioned processor related to the controller, or may be implemented by a single chip with a processor. The plurality of devices 110, 120, 130, 140, and 150 may be electrically, mechanically, and communicatively coupled to each other via the communication device 160.

According to an exemplary embodiment, the plurality of devices may perform Ethernet communication via the communication device. A process of performing Ethernet communication in the communication device of the plurality of devices will be briefly described. When a message is transmitted from one device to another device among the plurality of devices performing Ethernet communication, the communication device 160 may be configured to identify whether a communication network of the other device is occupied. In response to determining that the communication network of the other device is not occupied, the communication device 160 may be configured to transmit a message to the other device. In response to determining that the communication network of the other device is occupied, the communication device 160 is ready for a predetermined period of time, and then may be configured to identify again whether the communication network of the other device is occupied.

In addition, when a message is transmitted from one of the devices to two of the other devices among the plurality of devices performing Ethernet communication, the communication device 160 may be configured to identify whether communication networks of the two other devices are occupied. In response to determining that the communication networks of the two other devices are not occupied, the communication device 160 may be configured to transmit a message to the two other devices. However, simultaneously transmitting the message to the two other devices may result in a conflict. Accordingly, the communication device 160 may be configured to identify whether the message to be transmitted is damaged, and in response to determining that the message is damaged, the communication device 160 may be configured to again identify whether the communication networks of the two other devices are occupied after being ready for a predetermined period of time, and transmit the message.

In addition, in response to determining that a conflict occurs, the communication device 160 may be configured to transmit the message to the two other devices at predetermined time intervals. Accordingly, when transmitting the message to the other device, each device may be configured to transmit the message to the other device via a route generated in the communication device 160. The communication device 160 and the plurality of devices and performing the Ethernet communication may have the same network architecture. In other words, the plurality of devices and the communication device may be configured to perform communication based on the network architecture. This will be described with reference to FIGS. 3A and 3B.

The network architecture may include a total of seven layers. In other words, the network architecture may include a physical layer that corresponds to layer 1, a data link layer that corresponds to layer 2, a network layer that corresponds to layer 3, a transport layer that corresponds to layer 4, a session layer that corresponds to layer 5, a presentation layer that corresponds to layer 6 and an application layer that corresponds to layer 7. A framework for performing the network protocol may be defined in seven layers. In other words, it may be possible to define a method of movement from a device transmitting a message (i.e., a transmitting device) to a device receiving a message (i.e., a receiving device).

Particularly, the physical layer that corresponds to layer 1 defines a frame format to move a packet between devices, and provides a rule set for identifying how communicators react when two devices simultaneously use a single channel. In other words, the physical layer adjusts a function required for transmitting a bit stream through a physical medium. The data link layer that corresponds to layer 2 transmits a packet from one device to another device. The network layer that corresponds to layer 3 transmits a packet from one device to another device in a multi-network link. The transport layer that corresponds to layer 4 manages control and error between a transmitting device and a receiving device.

The network layer that corresponds to layer 3 and the transport layer that corresponds to layer 4, use an Internet standard, known as Transmission Control Protocol/Internet Protocol (TCP/IP) Suite, to transmit a message to one or more devices. The TCP/IP provide communication protocol features, which are required to perform a functional network (i.e., address assignment rule and mechanism for establishing a connection between a single device and exchange data).

The session layer that corresponds to layer 5 attempts to recover the connection when the connection is lost. When the connection fails over a long period of time, the session layer stops the connection and then restarts the connection. In other words, the session layer may identify and set whether a port connection is valid. As for the session layer that corresponds to layer 5, a port forming a communication session is provided. The session layer that corresponds to layer 5 performs synchronization while maintaining interactions between the communicators.

The presentation layer that corresponds to layer 6 serves as a data translator of the network. In particular, the presentation layer that corresponds to layer 6 is a part of the operating system. The presentation layer that corresponds to layer 6 converts data that is input or output, into a presentation form. For example, the presentation layer that corresponds to layer 6 performs serialization, encoding, and encryption. The application layer that corresponds to layer 7 allows the user to access the network.

As illustrated in FIG. 3A, a message transmitted from the first device 110 to the second device 120 will be described as an example. The application layer of the first device 110 may be configured to transmit a message to the transport layer. In particular, the transport layer of the first device 110 may be configured to receive the message from the application layer, divide the message to the packet, add a TCP header and then transmit the message to the network layer. The network layer of the first device 110 may be configured to count a destination IP to the received packet, count a trailer for error detection to the received packet, and transmit the IP packet including the trailer to the data link layer.

The data link layer of the first device 110 may include an Ethernet protocol, maybe configured to assign a Media Access Control (MAC) address that corresponds to a physical address, and transmit a packet, to which the MAC address is assigned, to the physical layer. The physical layer of the first device 110 may then be configured to transmit the packet to the communication device 160 in a hardware manner. In addition, upon the assignment of the mac address of the first device 110, the MAC address may be mapped to the destination IP address on a one to one basis.

Further, the data link layer of the first device 110 may be configured to count an Ethernet header to the IP packet. The data link layer of the first device 110 may be configured to perform framing on the IP packet message based on the network transmission method, and transmit the framed packet to the physical layer. The framed packet may be a frame and the frame may include a message, a header, and a trailer. The header may include a MAC address. In other words, the data link layer of the first device 110 may be configured to transmit the frame to the physical layer. The physical layer of the first device 110 may then be configured to change the frame to a bit, changes the bit to a signal, and transmit the signal to the communication device 160.

The communication device 160 may be configured to receive the packet of the first device 110 via the physical layer and transmit the received packet to the data link layer. The data link layer of the communication device 160 may be configured to identify a destination IP address that is mapped on the MAC address on a one to one basis, select a device, to which a message is to be transmitted, based on the identified destination IP address, and set a route based on the identification information of the selected device. When the selected device is the second device 120, the communication device 160 may connect the first device 110 to the second device 120 via communication.

The second device 120 may be configured to receive the packet through the physical layer, and transmit the received packet to the data link layer. The physical layer of the second device 120 may be configured to convert the received signal to a bit and transmit a frame that corresponds to the bit. The data link layer of the second device 120 may then be configured to transmit an IP packet, in which the Ethernet header is stripped from the received frame, to the network layer. The data link layer of the second device 120 may be configured to identify whether an error is present in the received IP packet. In response to determining that an error is not present, the data link layer of the second device 120 may be configured to transmit the IP packet to the network layer and in response to detect an error, the data link layer of the second device 120 may be configured to delete the IP packet.

The network layer of the second device 120 may be configured to identify a destination IP address and determine whether the second device 120 is a message reception target, based on the identified destination IP address. In response to determining that the second device 120 is a message reception target, the network layer of the second device 120 may be configured to determine whether a message to be received is present. In response to determining that a message to be received is present, the network layer of the second device 120 strips the IP header, and transmits the packet to the transport layer. In response to determining that the second device 120 is not a message reception target or in response to determining that a message to be received is not present, the network layer of the second device 120 may be configured to delete the received packet, and return the received packet to the data link layer and the physical layer.

When a TCP header is present, the transport layer of the second device 120 strips the TCP header, and transmits the message to the application layer via the session layer and the presentation layer. The application layer of the second device 120 may be configured to detect the message and output a user interface based on the recognized message.

As illustrated in FIG. 3B, when a message is transmitted from the first device 110 to the second device 120 and the fourth device 140 will be described as an example. The communication device 160 may be configured to select a device, to which a message is to be transmitted, based on the packet of the first device 110. When the selected device is the second device 120 and the fourth device 140, the communication device 160 may connect the first device 110 to the second device 120 via communication, and connect the first device 110 to the fourth device 140 via communication.

In the same manner as the second device 120, the fourth device 140 may be configured to receive the packet of the first device 110 through the physical layer, and transmit the received packet to the data link layer. The physical layer of the fourth device 140 may be configured to convert the received signal to a bit and transmit a frame that corresponds to the bit. The data link layer of the fourth device 140 be configured to transmit an IP packet, in which the Ethernet header is stripped from the received frame, to the network layer. The data link layer of the fourth device 140 be configured to determine whether an error is present in the received IP packet. In response to determining that an error is not present, the data link layer of the fourth device 140 be configured to transmit the IP packet to the network layer and in response to detecting an error, the data link layer of the fourth device 140 be configured to delete the IP packet.

The network layer of the fourth device 140 be configured to identify a destination IP address and whether the fourth device 140 is a message reception target, based on the identified destination IP address. In response to determining that the fourth device 140 is a message reception target, the network layer of the fourth device 140 be configured to determine whether a message to be received is present. In response to determining that a message to be received is present, the network layer of the fourth device 140 strips the IP header, and transmits the packet to the transport layer. In response to determining that the fourth device 140 is not a message reception target or that a message to be received is not present, the network layer of the fourth device 140 be configured to delete the received packet, and return the received packet to the data link layer and the physical layer.

When a bit assigned to the fourth device 140 is “1” among the destination IP address, the network layer of the fourth device 140 may be configured to identify that the fourth device 140 is a message reception target. When a TCP header is present, the transport layer of the fourth device 140 strips the TCP header, and transmits the message to the application layer through the session layer and the presentation layer.

The application layer of the fourth device 140 be configured to recognize the message and output a user interface based on the recognized message. In addition, the first device 110 may be configured to transmit the message to the fourth device 140 after transmitting the message to the second device 120. In this manner, it may be possible to transmit the message from one device to at least one other device.

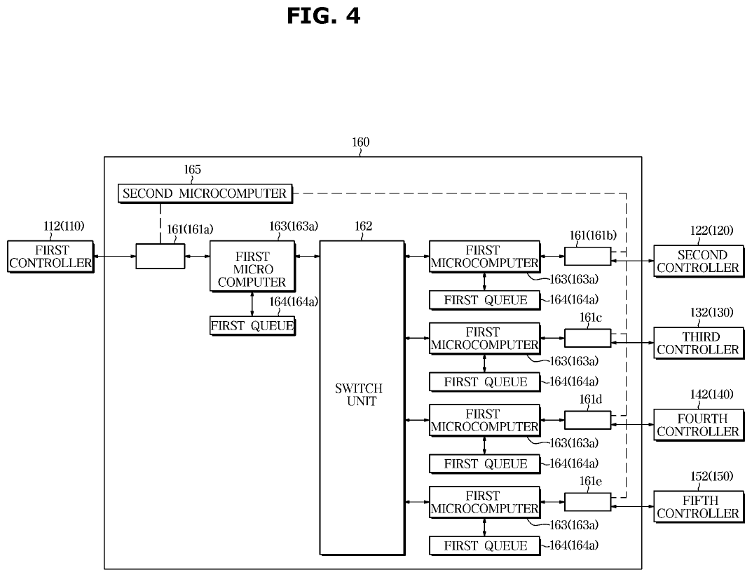

FIG. 4 is a block diagram illustrating the communication device provided with the vehicle according to an exemplary embodiment. The communication device 160 may include a plurality of ports 161, a switch unit 162, a plurality of first microcomputers 163, a plurality of queues 164, and a second microcomputer 165. The plurality of ports 161 (161a, 161b, 161c, 161d, and 161e) may be connection terminals to which devices are connected. The controllers 112, 122, 132, 142, and 152 of a plurality of devices may be connected to the plurality of ports 161 (161a, 161b, 161c, 161d, and 161e), respectively.

The communication units 111, 121, 131, 141, and 151 of the plurality of devices may be connected to the plurality of ports 161 (161a, 161b, 161c, 161d, and 161e), respectively. The plurality of ports 161 (161a, 161b, 161c, 161d, and 161e) may be connected to the plurality of first microcomputers 163a, 163b, 163c, 163d, and 163e, respectively, and be configured to transmit the received packet to the first microcomputer connected thereto. The switch unit 162 may be connected to the plurality of first microcomputers 163a, 163b, 163c, 163d, and 163e, and may be connected to the second microcomputer 165. The switch unit 162 may connect controllers of two devices that transmit and receive the packet.

When the wake-up packet is received from a controller connected to one of the plurality of ports, the switch unit 162 be configured to identify another controller to transmit the received wake-up packet, and perform converting with the port to which another controller is connected. The switch unit 162 be configured to store identification information of the plurality of controllers. The switch unit 162 may be configured to store the identification information that corresponds to each of the wake-up packets of the plurality of controllers in a table.

In response to determining that the packet received by the one port is the wake-up packet, the switch unit 162 be configured to identify the identification information of the wake-up packet, identify the controller that corresponds to the identified identification information, and select the identified controller as the controller to transmit the wake-up packet. When the wake-up packet is received, the switch unit 162 be configured to generate a wake-up signal, and transmit the generated wake-up signal to the identified controller.

The plurality of first microcomputers 163 (163a, 163b, 163c, 163d, and 163e) may be connected to the plurality of ports 161 (161a, 161b, 161c, 161d, and 161e), respectively, and may be connected to the switch unit 162. The plurality of first microcomputers 163 (163a, 163b, 163c, 163d, and 163e) may be connected to the plurality of queues 164 (164a, 164b, 164c, 164d, and 164e), respectively.

When the wake-up signal is received via the switch unit 162, each of the first microcomputers 163 (163a, 163b, 163c, 163d, and 163e) be configured to transmit the received wake-up signal to the controller via the port connected thereto. When the wake-up packet is received via the switch unit 162, the switch unit 162 may be configured to control the queue so that the received wake-up packet is stored in the queue connected thereto. When the wake-up packet is received, each of the first microcomputers 163 (163a, 163b, 163c, 163d, and 163e) may be configured to store only a messages in the received wake-up packet in the queue.

Each of the first microcomputers 163 (163a, 163b, 163c, 163d, and 163e) be configured to transmit the wake-up signal to the controller of the device connected to the port through the port, and when a ready signal is received from the controller of the device connected to the port, transmit the wake-up packet stored in the queue to the controller of the device through the port. When the ready signal is received from the controller connected to the port, each of the first microcomputers may be configured to transmit only the message in the wake-up packet stored in the queue.

Additionally, each of the first microcomputers 163 (163a, 163b, 163c, 163d, and 163e) be configured to delete the wake-up packet stored in the queue. In particular, when a reception completion signal of the wake-up packet is received via the port, each of the first microcomputers 163 (163a, 163b, 163c, 163d, and 163e) may be configured to delete the wake-up packet stored in the queue. When a predetermined time has elapsed since the transmission of the wake-up packet, each of the first microcomputers 163 (163a, 163b, 163c, 163d, and 163e) may be configured to delete the wake-up packet stored in the queue.

Each of the first microcomputers 163 (163a, 163b, 163c, 163d, and 163e) may be a controller configured to execute the operation of each queue. Each of the first microcomputers 163 (163a, 163b, 163c, 163d, and 163e) may be maintained in an off state, and may be turned on by the switch unit 162. In other words, when the wake-up signal is transmitted to the controller of the device via the port by the switch unit 162, each of the first microcomputers 163 (163a, 163b, 163c, 163d, and 163e) may be turned on. When each of the first microcomputers 163 (163a, 163b, 163c, 163d, and 163e) is turned on, each of the first microcomputers 163 (163a, 163b, 163c, 163d, and 163e) may be configured to control the storage of the wake-up packet. A wake-up packet P may be a packet including wake-up information for performing the wake-up of the device in the sleep mode and operation information for setting the function performed after the wake-up.

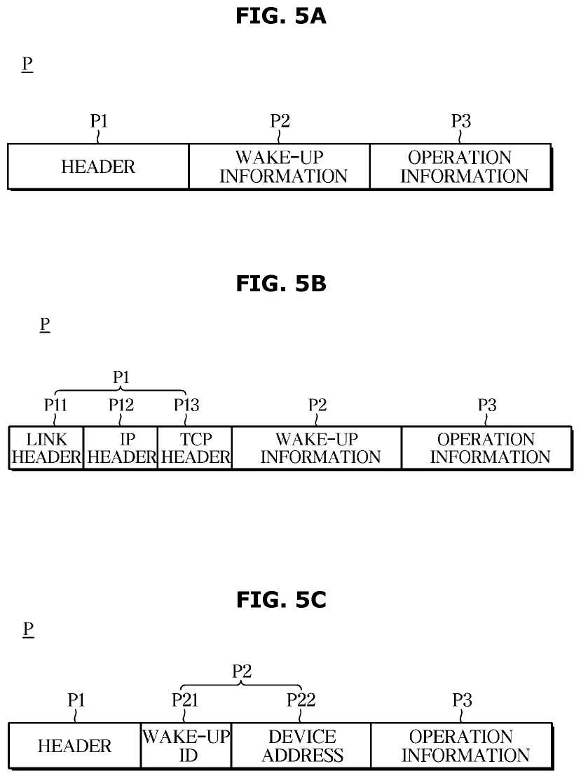

As shown in FIG. 5A, the wake-up packet P may include a header P1, wake-up information P2, and operation information P3. The header P1 may be generated based on a network scheme or protocol format between the devices. The wake-up information P2 may include a control command or control information to wake-up the one device selected by the user, and the operation information P3 may include a control command or control information to set a function selected by the user after the device is woken up. Locations of the wake-up information P2 and the operation information P3 may be interchangeable in the wake-up packet. The operation information P3 may include an operation code for each function of the device.

As shown in FIG. 5B, the header P1 in the wake-up packet P may include a link header P11, an IP header P12, and a UDP header P13. The header P1 may include address information of the communication device 160 and address information of another device to receive the wake-up packet P. In other words, when the wake-up packet includes address information of the plurality of devices, the wake-up packet may be transmitted to the plurality of devices.

When the wake-up packet includes address information of one device, the wake-up packet may be transmitted to the one device. The link header P11 may include medium access control (MAC) addresses or Ethernet addresses of the communication device 160 and the plurality of devices. The IP header P12 may include Internet Protocol (IP) addresses of the communication device 160 and the plurality of devices. The TCP header P13 may include port addresses of the communication device 160 and the plurality of devices.

As shown in FIG. 5C, the wake-up information P2 of the wake-up packet P may include wake-up identification (ID) P21 and device address P22. A wake-up ID P21 corresponds to a wake-up control command, e.g., a control command to power on or to wake-up the device from the sleep mode, which may be implemented, but not exclusively, by wake on local area network (WOL), wake on wireless local area network (WoWLAN), etc. The device address P22 refers to identification information of the device to be woken up. Locations of the wake-up ID P21 and the device address P22 may be interchangeable in the wake-up packet.

Furthermore, the wake-up information P2 may be implemented based on a predetermined standard protocol, e.g., a predetermined standard protocol that corresponds to the device to be woken up. The wake-up packet P may further include password information in addition to the header P1, the wake-up information P2, and the operation information P3. The password information may include a field of password length, and a field of a password. The password length refers to a length of the set password, and may have a value ranged from 0 to 16. When the password length has value 0, it indicates that there is no set password. The field of password length may be, for example, 1 byte long. The password may be a password for performing a wake-up operation, or a password for performing a function setting operation.

The plurality of queues 164 (164a, 164b, 164c, 164d, and 164e) may be provided in the plurality of ports 161 (161a, 161b, 161c, 161d, and 161e). The plurality of queues 164 (164a, 164b, 164c, 164d, and 164e) may be connected to the first microcomputers 163 (163a, 163b, 163c, 163d, and 163e), respectively. Each of the queues 164 (164a, 164b, 164c, 164d, and 164e) be configured to store the received wake-up packet in response to the control command of the first microcomputer. Each of the queues 164 (164a, 164b, 164c, 164d, and 164e) may be configured to store only the message in the received wake-up packet that corresponds to the control command of the first microcomputer. Each of the queues 164 (164a, 164b, 164c, 164d, and 164e) may be configured to delete the stored wake-up packet that corresponds to the control command of the first microcomputer. The queue 164 may be provided integrally with the first microcomputer connected thereto.

The second microcomputer 165 may be connected to the plurality of ports 161 (161a, 161b, 161c, 161d, and 161e), and may be connected to the switch unit 162. The second microcomputer 165 be configured to detect operation states of the plurality of devices based on signals transmitted and received via the plurality of ports 161 (161a, 161b, 161c, 161d, and 161e), and when at least one of the plurality of devices does not operate for a predetermined time or longer, convert the at least one device from the operating mode to the sleep mode. The second microcomputer 165 may be configured to convert a device determined not to be operated among the plurality of devices to the sleep mode.

When at least two devices are in the operating mode, the second microcomputer 165 be configured to execute transmission and reception of data between the at least two devices. The second microcomputer 165 may be configured to transmit and receive packets for data transmission and reception. When the wake-up packet is transmitted from one controller to another controller via the switch unit 162, the second microcomputer 165 may be configured to receive transmission and reception information of the wake-up packet from the switch unit 162.

The second microcomputer 165 may be connected to the plurality of ports, and may be configured to identify the transmission and reception information of the wake-up packet from the one controller to another controller by monitoring the plurality of ports. In response to determining that booting of the one device in the sleep mode is completed, the second microcomputer 165 may be configured to operate the one device so that the operating mode is performed in the one device. The second microcomputer 165 may be configured to receive a mode change signal for changing from the sleep mode to the operating mode by a controller of the one device. When two devices are in the operating mode, the second microcomputer 165 be configured to identify a destination IP address in a packet received by the controller of one of the two devices, and transmit the packet to the controller of the other device having the identified destination IP address.

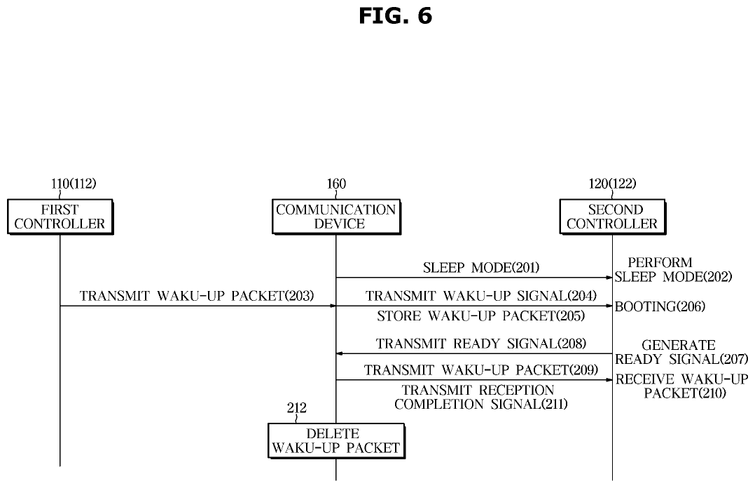

FIG. 6 is a flowchart illustrating an example of a control method of the communication device for communication between the plurality of devices provided in the vehicle according to an be configured to embodiment. The second microcomputer 165 of the communication device 160 be configured to monitor operation states of a plurality of devices by performing communication with controllers of the plurality of devices via the plurality of ports 161 (161a, 161b, 161c, 161d, and 161e).

In other words, the second microcomputer 165 of the communication device be configured to identify each of the operation states of the plurality of devices, and when at least one of the plurality of devices does not operate for a predetermined time or longer, transmit a converting signal for converting a sleep mode to the at least one device (201). At this time, the at least one device performs the sleep mode (202) when the converting signal for converting the sleep mode is received.

When the at least one device does not operate for a predetermined time or longer, the at least one device automatically converts to the sleep mode, and may be configured to transmit the converting signal for converting the sleep mode to the second microcomputer 165 of the communication device. If it is determined that the at least one device does not need to operate, the at least one device automatically converts to the sleep mode. The predetermined time is a time required to determine whether the at least one device does not need to operate. For example, in response to determining that the second device 120 is not operated for a predetermined time or longer, the communication device 160 may be configured to transmit the converting signal for converting the sleep mode to the second controller of the second device. At this time, the second controller of the second device be configured to change the operating mode to the sleep mode when the converting signal is received. The predetermined time may be a time corresponding to a boot time. For example. If the boot time is 5 seconds, the predetermined time may be 5 seconds or longer.

When the first controller of the first device provides information to the second device, or receives information from the second device during the execution of the operation mode, the first controller of the first device be configured to determine a current mode of the second device. In response to determining that the current mode is the sleep mode, the first controller may include the message to be transmitted to the second device in the wake-up packet, and be configured to transmit the wake-up packet containing the message to the communication device (203).

At this time, the switch unit 162 of the communication device may be configured to sense the wake-up packet received at the first port 161a. The switch unit 162 of the communication device be configured to determine identification information of the wake-up packet, determine a device having the identified identification information, and execute switching with the port connected to the identified device. For example, when the device having the identified identification information is a second device, the switch unit of the communication device may perform the connection between the first port 161a and the second port 161b.

In addition, in response to determining that the current mode of the second device is the operating mode, the first controller of the first device may be configured to transmit a data packet to the second device. At this time, the communication device may be configured to transmit the data packet received by the first port 161a to the second microcomputer 165. The communication device may be configured to perform switching with the second port 161b by operating the switch unit 162 in response to a control command of the second microcomputer 165. When the wake-up signal is received, the switch unit 162 of the communication device may be configured to generate a wake-up signal, and transmit the generated wake-up signal to the second controller of the second device via the second port 161b (204).

When transmitting the wake-up signal through the second port 161b of the communication device, the first microcomputer 163b may be changed from the off state to the on state. The queue 164b may also be changed from the off state to the on state. The first microcomputer 163b connected to the second controller of the second device among the plurality of first microcomputers 163 provided in the communication device be configured to operate the queue 164b to store the wake-up packet in the queue 164b. At this time, the queue 164b may be configured to store the wake-up packet (205). The queue 164b may be configured to store only the message of the wake-up packet.

When the wake-up signal is received via the second port of the communication device, the second controller 122 of the second device be configured to perform booting (206), when the booting is completed, generate a ready signal (207), transmit the generated ready signal to the first microcomputer 163b through the second port 161b of the communication device (208). When the ready signal is received, the first microcomputer 163b of the communication device be configured to transmit the wake-up packet stored in the queue 164b to the second controller of the second device via the second port 161b (209). At this time, the first microcomputer 163b of the communication device may be configured to transmit only the message of the wake-up packet to the second controller of the second device.

The second controller 122 of the second device be configured to receive the wake-up packet transmitted via the second port 161b (210), determine the reception completion state of the received wake-up packet, and in response to determining that the reception of the wake-up packet is completed, transmit a reception completion signal to the communication device (211). When the reception completion signal is received from the second controller 122 of the second device, the first microcomputer 163b of the communication device be configured to delete the wake-up packet stored in the queue 164b (212).

When the second microcomputer of the communication device determines that the booting of the second device is completed, the second microcomputer of the communication device be configured to recognize the current mode of the second device as the operating mode, and execute transmission and reception of data between the first controller of the first device and the second controller of the second device.

As is apparent from the above description, a communication device, a vehicle having the same and method for controlling the communication device in accordance with one exemplary embodiment of the present disclosure may operate some controllers unnecessary during operation of the vehicle, such as a CAN (CAN Partial Network), even in Ethernet communication, and in a sleep mode, thereby minimizing the power consumption of the vehicle.

Further, a communication device, a vehicle having the same and method for controlling the communication device in accordance with another exemplary embodiment of the present disclosure may transmit the packet at high speed by transmitting the wake-up signal and a packet using relatively inexpensive hardware, without adding software for packet transmission. Thus, it may be possible to improve the speed of performing the function in the controller.

Additionally, a communication device, a vehicle having the same and method for controlling the communication device in accordance with another exemplary embodiment of the present disclosure may increase the transmission success rate of a packet by transmitting a wake-up signal, storing the packet in a queue, and then transmitting the packet stored in the queue when a reception object controller is ready to receive the packet. Accordingly, the number of packet retransmissions may be reduced, and the network may be efficiently used between the controllers.

Lastly, a communication device, a vehicle having the same and method for controlling the communication device in accordance with another exemplary embodiment of the present disclosure may solve the problem that a reception object controller does not receive a packet (including a message) due to the transmission time of a wake-up signal and the booting time of the controller for wake-up. It may be possible to improve the quality of the communication device and the vehicle, and further increase the user's satisfaction, thereby improving the user's convenience.

Meanwhile, the disclosed exemplary embodiments may be embodied in the form of a recording medium storing instructions executable by a computer. The instructions may be stored in the form of a program code and, when executed by a processor, may generate a program module to perform the operations of the disclosed embodiments. The recording medium may be embodied as a non-transitory computer-readable recording medium. The non-transitory computer-readable recording medium includes all types of recording media in which instructions which can be decoded by a computer are stored. For example, there may be Read Only Memory (ROM), Random Access Memory (RAM), a magnetic tape, a magnetic disk, a flash memory, and an optical data storage device.

Although a few exemplary embodiments of the present disclosure have been shown and described, it would be appreciated by those skilled in the art that changes may be made in these exemplary embodiments without departing from the principles and spirit of the disclosure, the scope of which is defined in the claims and their equivalents.

What is claimed is:

1. A communication device, comprising:
a plurality of ports respectively connected to a plurality of controllers;
a switch unit configured to, when a wake-up packet is received by a first controller connected to one of the plurality of ports, identify a second controller to transmit the received wake-up packet, and perform switching with the port to which the identified second controller is connected;
a queue configured to store the received wake-up packet; and
a first microcomputer configured to transmit a wake-up signal to the second controller, and when a ready signal is received by the second controller, transmit the wake-up packet stored in the queue to the second controller.

2. The communication device of claim 1, wherein the switch unit is configured to store identification information of the plurality of controllers.

3. The communication device of claim 1, further comprising:
a second microcomputer configured to identify an operation state of the plurality of controllers, and when at least one controller among the plurality of controllers is not operated for a predetermined time or longer, convert the at least one controller from an operating mode to a sleep mode.

4. The communication device of claim 3, wherein, when the at least one controller is in the operating mode, the second microcomputer is configured to transmit and receive data with another controller.

5. The communication device of claim 1, wherein, when the ready signal is received by the second controller, the first microcomputer is configured to transmit a message in the wake-up packet stored in the queue.

6. The communication device of claim 1, wherein, when a packet transmitted by the first controller connected to one of the plurality of ports is the wake-up packet, the switch unit is configured to generate the wake-up signal.

7. The communication device of claim 6, wherein the switch unit is configured to store identification information corresponding to each of the plurality of controllers in a table.

8. The communication device of claim 1, wherein, when transmission of the wake-up packet stored in the queue is completed, the first microcomputer is configured to delete the wake-up packet stored in the queue.

9. A vehicle, comprising:
a plurality of controllers; and
a communication device configured to, when receiving a wake-up packet to be transmitted from a first controller to a second controller among the plurality of controllers, store the received wake-up packet, transmit a wake-up signal to the second controller, and when a ready signal is received by the second controller, transmit the stored wake-up packet to the second controller.

10. The vehicle of claim 9, wherein the communication device includes:
a plurality of ports respectively connected to the plurality of controllers;
a plurality of first microcomputers respectively connected to the plurality of ports, and configured to store and transmit the wake-up packet;
a plurality of queues respectively connected to the plurality of first microcomputers, and configured to store the wake-up packets;
a switch unit configured to identify the second controller to transmit the wake-up packet, and perform switching with the port to which the identified second controller is connected; and
a second microcomputer connected to the plurality of ports, and configured to execute a sleep mode of the plurality of controllers, and execute transmitting and receiving data between the controllers performing an operating mode of the plurality of controllers.

11. The vehicle of claim 10, wherein the switch unit of the communication device is configured to store identification information corresponding to each of the plurality of controllers in a table.

12. The vehicle of claim 10, wherein the second microcomputer of the communication device is configured to identify an operation state of the plurality of controllers, and when at least one controller among the plurality of controllers is not operated for a predetermined time or longer, convert the at least one controller from the operating mode to the sleep mode.

13. The vehicle of claim 10, wherein, when a packet transmitted by the first controller connected to one of the plurality of ports is the wake-up packet, the switch unit of the communication device is configured to generate the wake-up signal.

14. The vehicle of claim 9, wherein the communication device is configured to store the received wake-up packet in a queue, when the ready signal is received by the second controller, transmit the wake-up packet stored in the queue, and when transmission of the wake-up packet stored in the queue is completed, delete the wake-up packet stored in the queue.

15. The vehicle of claim 9, wherein the communication device includes an Ethernet switch hub.

16. The vehicle of claim 9, wherein, when the wake-up signal is received, the second microcomputer is configured to perform a boot, and when booting is complete, transmit the ready signal to the communication device.

17. A method for controlling a communication device, comprising:
when receiving a wake-up packet by a first controller connected to one of a plurality of ports, identifying a second controller to transmit the received wake-up packet;
performing switching with the port to which the identified second controller is connected;
storing the received wake-up packet in a queue;
transmitting a wake-up signal to the identified second controller; and
when a ready signal is received by the second controller, transmitting the wake-up packet stored in the queue to the second controller.

18. The method of claim 17, wherein the transmitting of the wake-up packet stored in the queue to the second controller includes:
transmitting a message in the wake-up packet stored in the queue.

19. The method of claim 17, further comprising:
when a packet transmitted by the first controller is the wake-up packet, generating the wake-up signal.

20. The method of claim 17, further comprising:
when transmission of the wake-up packet stored in the queue is completed, deleting the wake-up packet stored in the queue.
